(19) United States
(12) Patent Application Publication
(10) Pub. No.: US 2026/0141250 A1
(43) Pub. Date: May 21, 2026

(54) JOINTLY TRAINED SEMANTIC EMBEDDINGS FOR IMPROVED PREDICTIONS

(71) Applicant: DoorDash, Inc., San Francisco, CA (US)

(72) Inventors: Kin Sum Liu, Santa Clara, CA (US); Praveen Kolli, Sunnyvale, CA (US); Utsaw Kumar, Foster City, CA (US); Mandar Rahurkar, Menlo Park, CA (US); Omkar Gurjar, Champaign, IL (US)

(73) Assignee: DoorDash, Inc., San Francisco, CA (US)

(21) Appl. No.: 19/389,999

(22) Filed: Nov. 14, 2025

Related U.S. Application Data
(60) Provisional application No. 63/720,986, filed on Nov. 15, 2024.

(51) Int. Cl. G06N 3/09; G06N 3/045

(52) U.S. Cl. CPC G06N 3/09; G06N 3/045

(57) ABSTRACT

A method includes a computer generating a multimodal embedding using a first machine learning model. The computer obtains a labeled training query. The computer trains a second machine learning model using the labeled training query and the multimodal embedding to predict items related to multimodal embeddings based on queries.

### CROSS-REFERENCES TO RELATED APPLICATIONS

This application claims the benefit of U.S. Provisional Application No. 63/720,986, filed Nov. 15, 2024, which is herein incorporated by reference in its entirety for all purposes.

### SUMMARY

One embodiment is related to a method comprising: generating, by a computer, a multimodal embedding using a first machine learning model; obtaining, by the computer, a labeled training query; and training, by the computer, a second machine learning model using the labeled training query and the multimodal embedding to predict items related to multimodal embeddings based on queries.

Another embodiment is related to a computer comprising: a processor; and a non-transitory computer readable medium comprising code, executable by the processor for performing a method comprising: generating a multimodal embedding using a first machine learning model; obtaining a labeled training query; and training a second machine learning model using the labeled training query and the multimodal embedding to predict items related to multimodal embeddings based on queries.

Another embodiment is related to a system comprising: an item database; and a computer comprising: a processor; and a non-transitory computer readable medium comprising code, executable by the processor for performing a method comprising: generating a multimodal embedding for an item of the item database using a first machine learning model; obtaining a labeled training query; and training a second machine learning model using the labeled training query and the multimodal embedding to predict items related to multimodal embeddings based on queries.

Further details regarding embodiments of the disclosure can be found in the Detailed Description and the Figures.

### BRIEF DESCRIPTION OF THE DRAWINGS

FIG. 1A shows a block diagram of a system according to embodiments.

FIG. 1B shows a flow diagram illustrating a preparation and delivery method of an item according to embodiments.

FIG. 2 shows a block diagram of components of a central server computer according to embodiments.

FIG. 3 shows a hybrid diagram illustrating model architecture and training objectives according to embodiments.

FIG. 4 illustrates a plot of item embeddings according to embodiments.

FIG. 5A illustrates a probability density plot of similarity according to previous models.

FIG. 5B illustrates a probability density plot of similarity according to embodiments.

FIG. 6 shows a diagram illustrating model architecture for integrating embedding features with another model according to embodiments.

FIG. 7 shows a flow diagram illustrating a query and response method according to embodiments.

### DETAILED DESCRIPTION

Prior to discussing embodiments of the disclosure, some terms can be described in further detail.

An “item” can be an individual article or unit. Examples of items can include perishable items such as food items, beauty items (e.g., cosmetics), office supply products (e.g., staples, paper, and ink), hardware items (e.g., nails, hammers, wrenches), electronic devices (e.g., computers, phones, etc.), jewelry, etc.

A “user” may include an individual or a computational device. In some embodiments, a user may be associated with one or more personal accounts and/or mobile devices. In some embodiments, the user may be a consumer or a customer.

A “user device” may be a device that is operated by a user. In some embodiments, the user device can be an electronic device that can process information and communicate with other electronic devices. A user device may include a processor and a computer-readable medium coupled to the processor, the computer-readable medium comprising code, executable by the processor. Examples of user devices may include a mobile device, a laptop or desktop computer, a wearable device, etc.

A “transporter” can be an entity that transports something. A transporter can be a person that transports an item using a transportation device (e.g., a car). In other embodiments, a transporter can be a transportation device that may or may not be operated by a human. Examples of transportation devices include cars, boats, scooters, bicycles, drones, airplanes, etc. In some embodiments, the user device can be integrated into a transportation device. A transporter can be an autonomous vehicle such as an autonomous car or autonomous drone.

A “fulfillment request” can be a request to provide a resource in response to a request. For example, a fulfillment request can include an initial communication from an end user device to a central server computer for a first service provider computer to fulfill a purchase request for a resource such as food. A fulfillment request can be in an initial state, a completed state, or a final state. A fulfillment request can include one or more selected items that a user wishes to obtain from a selected service provider.

A “delivery order” can include a request to deliver one or more items. Delivery orders can include requests to provide one or more items from a pickup location to a drop-off location. Delivery orders can include orders to deliver items from service provider locations to end user locations. Delivery orders can include orders to deliver items from end user locations to service provider locations. An example of this type of delivery order can be a return order (e.g., to deliver an item that is to be returned). A delivery order can include data to fulfill the delivery request including an order type, an indication of an item, a pickup location, and a drop-off location. In some embodiments, the delivery order can include a scheduling range by which the order is to be fulfilled. A delivery order can also include metadata. The metadata can include data relating to the delivery order (e.g., related order numbers, instruction data, etc.).

A “route” can include a way or course taken in getting from a starting point to a destination. For example, a route can indicate a path that can be followed to move from a pickup location to a drop-off location. In some embodiments, a route can indicate a suggested path that a transporter can follow to deliver an item from a service provider to an end user (or vice-versa) for a delivery order. A route can be a journey between two locations.

A “machine learning computer” can include a device that creates, trains, and/or otherwise manipulates models. A machine learning computer can train a machine learning model.

A “machine learning model” (ML model) can include a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

An “encoder” can process an input sequence to create a vector. Encoders can process input sequences to generate embedding vectors. An encoder can encode data from a higher dimensionality to a lower dimensionality. A “decoder” can process a vector to create an output sequence. Decoders can process embedding vectors, or vectors modified therefrom, to generate an output sequence. A decoder can decode data from a lower dimensionality to a higher dimensionality. Both encoders and decoders can be separate, fully connected neural networks. Encoders and decoders may be recurrent neural networks (RNNs) or variants thereof (e.g., long-short term memory (LSTM), gated recurrent units (GRUs), etc.) and convolutional neural networks (CNNs), as well as transformer models. An encoder-decoder model can include several encoders and several decoders.

An “embedding” can include numerical representations. An embedding can include a vector. An embedding can be a lower-dimensional vector that is derived from complex high-dimensional data.

A “multimodal embedding” can include a numerical representation that is generated by processing and integrating data from two or more distinct modalities. A multimodal embedding can be an embedding that is generated based on image data and text data. A multimodal embedding can include a vector, or a set of vectors, that encapsulates the salient features and semantic content derived from each modality. The generation of a multimodal embedding may involve the use of one or more encoders, such as neural network architectures, including, but not limited to, convolutional neural networks (CNNs), recurrent neural networks (RNNs), transformer models, and their variants, which are configured to extract and combine features from each modality. A multimodal embedding can serve as a unified, information-rich representation suitable for downstream tasks such as classification, retrieval, matching, or semantic analysis across modalities.

An “image embedding” can include a numerical representation that is generated based on image data. An image embedding can include a vector, or a set of vectors, that encapsulates visual features and semantic content derived from an input image.

A “text embedding” can include a numerical representation that is generated based on text data. A text embedding can include a vector, or a set of vectors, that encapsulates textual features and semantic content derived from input text.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A machine learning computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (e.g., be made to have unit magnitude). As an example, the feature vector (12, 15, 22, 5) corresponding to “LOVE” could be normalized to approximately (0.40, 0.51, 0.74, 0.17).

A “query” can include a request for information or a search instruction. A query can indicate a request to retrieve, rank, and/or identify relevant items, data, or results from a database. A query can include natural language text, keywords, phrases, structured data, or other forms of input submitted by a user, another computing device, or a software application.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Current search and recommendation models for recommending items use only limited information from item catalogs, mainly focusing on item identity and simple query features. This approach misses the rich semantic information in item images and text that could enhance search relevance and user engagement.

Existing models primarily use item identity and basic query features to determine item relevance. These models do not fully leverage available item metadata or visual information.

Existing methods have a limited semantic understanding. The models do not utilize the rich semantic information available in the item catalog. Important contextual data, particularly from item images and more descriptive text fields, remains difficult to utilize.

Further, current methods have minimal query alignment with items. The models do not fully align with user search intent, especially since item and query embeddings are not jointly optimized to capture their mutual relevance.

Such embeddings inherit biases present in user engagement data, particularly item popularity. As a result, popular items may be overly favored in recommendations, while less popular or new items receive less exposure, which can limit diversity and relevance in search results.

Embodiments of the disclosure address these technical challenges and other problems individually and collectively.

Embodiments of the disclosure allow for a joint training framework designed to learn multimodal embeddings for item catalogs (e.g., produce catalogs) and user search queries. Doing so can enable an application to improve the relevance of items show to users. Embodiments provide for a combination of uni-modal and multi-modal encoders to align item images, text, and user queries into a shared embedding space, allowing for a more accurate understanding of item-query relevance. Embodiments demonstrate robust generalization to new data, scalability for large-scale production deployment, and flexibility for integration into other components.

To enhance item query relationships, embodiments provide for a versatile, semantic embedding model that learns unified representations for both items and user queries. Unlike existing models that rely on limited item attributes or previous user-item interaction, embodiments capture a rich, multimodal understanding of item features and user intent through jointly trained image, text, and query encoders. This semantic embedding serves as a generalizable foundation for various applications, from item categorization to relevance prediction. Experimentations demonstrated strong performance gains in both offline and online metrics, including a notable uplift in clickthrough rate (CTR) and conversion.

Embodiments provide for a model that utilizes a vision-language pre-training framework with uni-modal image and text encoders, an image-grounded text encoder, and a query encoder for processing user search terms. The model can undergo a two-stage training process involving fine-tuning item encoders on item catalog data and aligning them with query encoders using a relevance dataset generated through a hybrid approach combining human annotations and LLM inferences.

The system architecture includes a set of specialized neural encoders. The encoders include a text encoder, an image encoder, an image-text encoder, and a query encoder. These components are trained in a two-stage process. In the first stage, the image and text encoders are continually pre-trained using image-title pairs from an item database (e.g., an item catalog). The second stage involves aligning the representations of items (e.g., item embeddings) and user queries through a contrastive loss function, using a relevance dataset synthesized through a hybrid methodology combining large-scale human annotation and machine inference via a fine-tuned large language model.

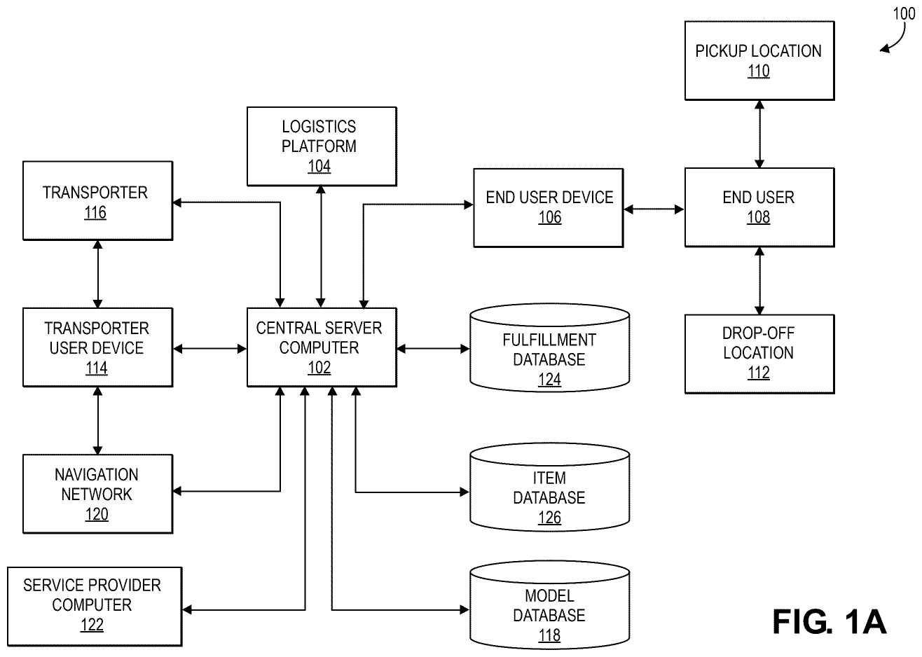

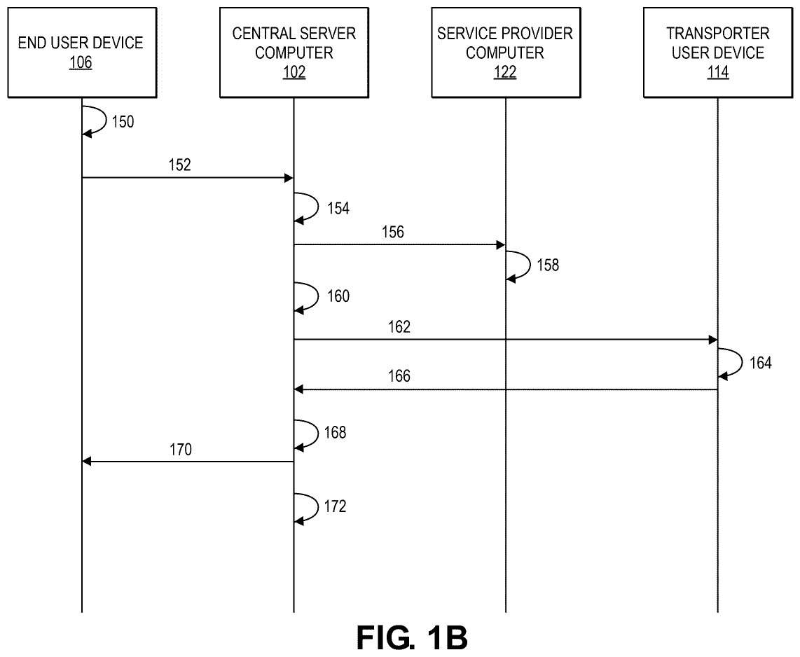

FIG. 1 shows a system 100 according to embodiments of the disclosure. The system of FIG. 1 includes a central server computer 102, a logistics platform 104, an end user device 106, an end user 108, a pickup location 110, a drop-off location 112, a transporter user device 114, a transporter 116, model database 118, a navigation network 120, a service provider computer 122, a fulfillment database 124, and an item database 126.

The central server computer 102 can be in operative communication with the logistics platform 104, the end user device 106, the transporter user device 114, the navigation network 120, the service provider computer 122, the fulfillment database 124, and the model database 118, and the item database 126. The transporter user device 114 can be in operative communication with the navigation network 120.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. For example, although FIG. 1 shows one transporter 116, there can be two, three, or more transporters, transporter user devices, etc.

Messages between the devices and the computers in the system 100 in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The central server computer 102 can include a server computer that can facilitate in the fulfillment of fulfillment requests received from the end user device 106. For example, the central server computer 102 can identify the transporter 116 (from among many candidate transporters) operating the transporter user device 114 as being suitable for satisfying the fulfillment request. The central server computer 102 can identify the transporter user device 114 that can satisfy the fulfillment request based on any suitable criteria (e.g., transporter location, service provider location, end user destination, end user location, transporter mode of transportation, etc.).

The central server computer 102 can receive data relating to a delivery order of items from the service provider computer 122 to the end user 108 at the drop-off location 112. The central server computer 102 can determine a route for delivery of the delivery order. The central server computer 102 can present the routes to a plurality of transporter user devices and/or transporters. The central server computer 102 can receive acceptances from the transporter 116 that will deliver the items from the pickup location 110 to the drop-off location 112.

The logistics platform 104 can include a location determination system, which can determine the locations of various user devices such as transporter user devices (e.g., the transporter user device 114) and end user devices (e.g., the end user device 106). The logistics platform 104 can also include routing logic to efficiently route transporters using the transport user devices to various pickup locations that have the packages that are to be delivered to drop-off locations. In some embodiments, if the transporter is an autonomous vehicle and the transporter user device is a component of the autonomous vehicle, then the routing logic may be used to control and automatically route the autonomous vehicle according to determined paths. Efficient routes can be determined based on the locations of the transporters, the locations of the pickup locations, the locations of the drop-off locations, as well as external data such as traffic patterns, the weather, etc. The logistics platform 104 can be part of the central server computer 102 or can be system that is separate from the central server computer 102.

The end user device 106 can include a device operated by the end user 108. The end user devices 106 can generate and provide fulfillment request messages to the central server computer 102. The fulfillment request message can indicate that the request (e.g., a request for a service) can be fulfilled by the service provider computer 122. For example, the fulfillment request message can be generated based on a cart selected at checkout during a transaction using a central server computer application installed on the end user device 106. The fulfillment request message can include one or more items from the selected cart.

The end user device 106 can provide a fulfillment request message to the central server computer 102 that indicates that the end user device 106 is requesting that the transporter 116 pick up an item from the pickup location 110 (e.g., end user's 108 location) and deliver the item to the drop-off location 112 (e.g., the service provider computer's 122 location).

The pickup location 110 can be a location in which items are stored. In the context of an outbound delivery from an end user at an end user location, examples of the pickup location 110 may be a house or an apartment, a mailbox, a service provider location (e.g., a retail store, a grocery store, a dry cleaning store), a pickup hub, etc. Items can first be obtained from a pickup location 110 and then be transported to the drop-off location 112. Examples of the drop-off location 112 can be similar to the pickup location 110, such a house or apartment, a mailbox, a retail store, a grocery store, a dry cleaning store, a pickup hub, etc. In one example, the pickup location 110 can be a pizza parlor from which the end user 108 orders a pizza. The drop-off location 112 can be an apartment in which the end user 108 resides.

The transporter user device 114 can include a device operated by the transporter 116. The transporter user device 114 can include a smartphone, a wearable device, a personal assistant device, etc. The transporter 116 can accept an end user's fulfillment request via an acceptance message. For example, the transporter user device 114 can generate and transmit a request to fulfil a particular end user's fulfillment request to the central server computer 102. The central server computer 102 can notify the transporter user device 114 of the fulfillment request. The transporter user device 114 can respond to the central server computer 102 with a request to perform the delivery to the end user as indicated by the fulfillment request.

In some embodiments, the transporter 116 can be an operator of a vehicle. In other embodiments, the transporter 116 can be a vehicle that can operated by an operator or can be autonomous. The vehicle can include a car, a truck, a van, a motorcycle, a bicycle, a drone, or other vehicle. In some embodiments, the transporter user device 114 can be part of the transporter 116 if the transporter 116 is a vehicle.

The navigation network 120 can provide navigational directions to the transporter user device 114. For example, the transporter user device 114 can obtain a location from the central server computer 102. The location can be a service provider parking location, a service provider location, an end user parking location, an end user location, etc. The navigation network 120 can provide navigational data to the location. For example, the navigation network 120 can be a global positioning system that provides location data to the transporter user device 114.

The service provider computer 122 include computers operated by a service provider. For example, the service provider computer 122 can be a food provider computer that is operated by a food provider. The service provider computer 122 can offer to provide services to the end user 108 of the end user device 106. In embodiments of the invention, the service provider computer 122 can receive requests to prepare one or more items for delivery from the central server computer 102. The service provider computer 122 can initiate the preparation of the one or more items that are to be delivered to the end user 108 of the end user device 106 by the transporter 116 of the transporter user device 114.

The fulfillment database 124 can include any suitable database. The database may be a conventional, fault tolerant, relational, scalable, secure database such as those commercially available from Oracle™ or Sybase™. The fulfillment database 124 can store location data (e.g., a location that includes a latitude and longitude, etc.) and time data (e.g., a specific time).

The model database 118 can similarly be a conventional, fault tolerant, relational, scalable, secure database. The model database 118 can store machine learning models. The model database 118 can store machine learning models.

The item database 126 can similarly be a conventional, fault tolerant, relational, scalable, secure database. The item database 126 can store item data. The item database 126 can store item data for a plurality of items that are provided by service providers to end users via transporters. The item data can include item names, item descriptions, item images, item costs, item weights, item quantities, item categories, and/or any other data related to the creation of the item, the intrinsic properties of the item, and/or the process of providing the item to an end user.

FIG. 1B shows a flow diagram illustrating a preparation and delivery method of an item according to embodiments. The method illustrated in FIG. 1B will be described in the context of the central server computer 102 receiving a fulfillment request message from the end user device 106 to fulfill preparation and delivery of one or more items from a cart to the end user of the end user device 106. The central server computer 102 can communicate with the service provider computer 122 and the transporter user device 114 to fulfill the fulfillment request.

At step 150, the end user device 106 can decide to check out with a cart in a central server computer delivery application installed on the end user device 106. The cart can include one or more items that are provided from a service provider of the service provider computer 122.

At step 152, after checking out with the cart, the end user device 106 can provide a fulfillment request message including the one or more items from the cart to the central server computer 102. The fulfillment request message can also include a service provider computer identifier that identifies the service provider computer 122.

At step 154, after receiving the fulfillment request message, the central server computer 102 can perform a transaction process with the end user device 106. For example, the central server computer 102 can communicate with a payment network to process the transaction for the one or more items. The central server computer 102 can receive an indication of whether or not the transaction is authorized. If the transaction is authorized, then the central server computer 102 can proceed with step 208.

At step 156, the central server computer 102 can provide the fulfillment request message, or a derivation thereof, to the service provider computer 122. The central server computer 102 can determine which service provider computer of a plurality of service provider computers to communicate with based on the service provider indicated in the fulfillment request message. For example, the fulfillment request message can indicate that the one or more items are provided by the service provider of the service provider computer 122. The central server computer 102 can identify the service provider computer 122 using the service provider computer identifier in the fulfillment request message.

At step 158, after receiving the fulfillment request message, the service provider computer 122 can initiate preparation of the one or more items. For example, the service provider computer 122 can alert service provider personnel (e.g., those preparing the items) at the service provider location. The service providers can prepare the one or more items for pick up by a transporter.

At step 160, after providing the fulfillment request message to the service provider computer 122, the central server computer 102 can determine one or more transporters operating one or more user devices that are capable of fulfilling the fulfillment request message. The central server computer 102 can determine the one or more transporters from the transporter user devices. The central server computer 102 can determine the one or more transporter user devices based on whether or not the transporter user device is online, whether or not the transporter user device 114 is already fulfilling a different fulfillment request message, a location of the transporter user device 114, etc.

At step 162, after determining the one or more transporter user devices, the central server computer 102 can provide the fulfillment request message, or a derivation thereof, to the one or more transporter user devices including the transporter user device 114.

At step 164, after receiving the fulfillment request message, the transporter of the transporter user device 114 can determine whether or not they want to perform the fulfillment. The transporter can decide that they want to perform the delivery of the one or more items from the service provider location to the end user location. The transporter user device 114 can generate an acceptance message that indicates that the fulfillment request is accepted.

At step 166, after generating the acceptance message, the transporter user device 114 can provide the acceptance message to the central server computer 102.

After providing the acceptance message to the central server computer 102, the transporter user device 114 can communicate with a navigation network and the transporter can proceed to the service provider location to obtain the one or more items. In some embodiments, if the transporter is an autonomous vehicle and the transporter user device 114 is a component of the autonomous vehicle, then received routing logic from the central server computer 102 may be used to control and automatically route the autonomous vehicle according to determined paths The transporter user device 114 can then receive input from the transporter that indicates that the transporter obtained the one or more items (e.g., the transporter selects that they picked up the items). The transporter user device 114 can then communicate with the navigation network and the transporter can then proceed to the end user location to provide the one or more items to the end user. In some embodiments, the transporter user device 114 can provide update messages to the central server computer 102 that include a transporter user device 114 location and/or event data (e.g., items picked up, items delivered, etc.).

In some embodiments, after receiving the acceptance message, the central server computer 102 can notify the other transporter user devices that received the fulfillment request message that the fulfillment request is no longer available.

At step 168, at any point after receiving the acceptance message, the central server computer 102 can check the status of the fulfillment request. For example, the central server computer 102 can determine the location of the transporter user device 114 and can determine an estimated amount of time for the transporter user device 114 to arrive at the end user location.

At step 170, the central server computer 102 can provide an update message to the end user device 106 that includes data related to the fulfillment of the fulfillment request message. The data can include an estimated amount of time, the transporter user device location, event data (e.g., items picked up from the service provider), and/or other data related to the fulfillment of the fulfillment request message.

At step 172, the central server computer 102 can store any data received, sent, and/or processed during the fulfillment of the fulfillment request message into a database. For example, the central server computer 102 can store a user's cart selection as user features into a user feature database.

In some embodiments, the end user may search for a particular item using a search bar. In such case, the central server computer 102 can use image filtering to surface contextualized images on the search feed that includes the item related to what an end user has searched. By providing the image related to what the user has searched, the user does not have to search through an entire menu to look for an item. For example, when a user searches for a “burger”, images related to the word “burger” for merchants are displayed in a screen.

In some embodiments, the plurality of images can be images of the plurality of service providers and the inquiry request can be with respect to determining a service provider of the plurality of service providers. For example, an image can be an image of an item that can be provided by the service provider to the end user via the transporter.

For example, the central server computer can determine which service providers are displayed on the homepage. The homepage of the delivery application can have a plurality of “slots” that each can display a service provider. For each slot on the homepage, the central server computer can use a scoring algorithm to determine a service provider of the plurality of service providers to display in the delivery application.

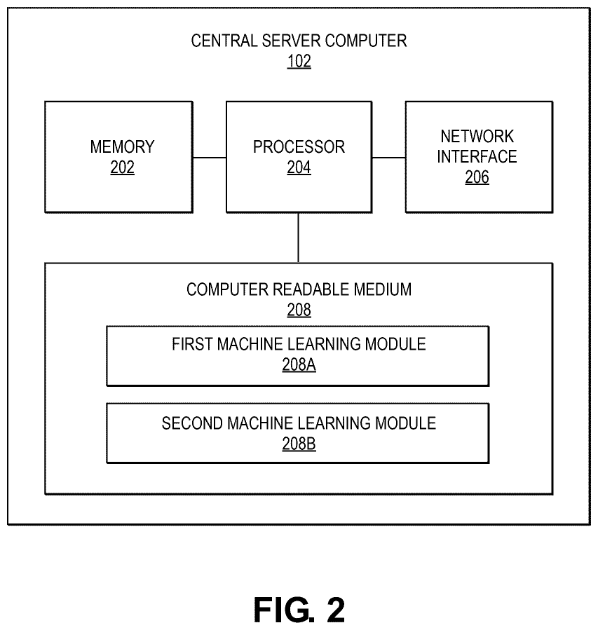

FIG. 2 shows a block diagram of a central server computer 102 according to embodiments. The exemplary central server computer 102 may comprise a processor 204. The processor 204 may be coupled to a memory 202, a network interface 206, and a computer readable medium 208. The computer readable medium 208 can comprise a first machine learning module 208A and a second machine learning module 208B.

The memory 202 can be used to store data and code. For example, the memory 202 can store machine learning models, model weights, training data, fulfillment data, item data, queries, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: generating, by a computer, a multimodal embedding using a first machine learning model; obtaining, by the computer, a labeled training query; and training, by the computer, a second machine learning model using the labeled training query and the multimodal embedding to predict items related to multimodal embeddings based on queries.

The first machine learning module 208A may comprise code or software, executable by the processor 204, for training, utilizing, and maintaining a first machine learning model. The first machine learning model can include an image encoder, a text encoder, and an image-text encoder. The first machine learning model can receive item data as input and can determine multimodal embeddings that represent the item data as output. The first machine learning module 208A, in conjunction with the processor 204, can train the first machine learning model by optimizing loss functions and updating model weights over training iterations to improve how well output multimodal embeddings represent the input item data.

The second machine learning module 208B may comprise code or software, executable by the processor 204, for training, utilizing, and maintaining a second machine learning model. The second machine learning model can include a query encoder. The second machine learning model can receive a query as input and can determine a classification that indicates how well the query relates to a particular item associated with a multimodal embedding. The second machine learning module 208B, in conjunction with the processor 204, can train the second machine learning model by optimizing loss functions and updating model weights over training iterations to improve how well output classifications indicate the relationship between a query and an item as represented by a multimodal embedding.

The network interface 206 may include an interface that can allow the central server computer 102 to communicate with external computers. The network interface 206 may enable the central server computer 102 to communicate data to and from another device (e.g., the logistics platform 104, the end user device 106, the transporter user device 114, the model database 118, the service provider computer 122, the fulfillment database 124, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

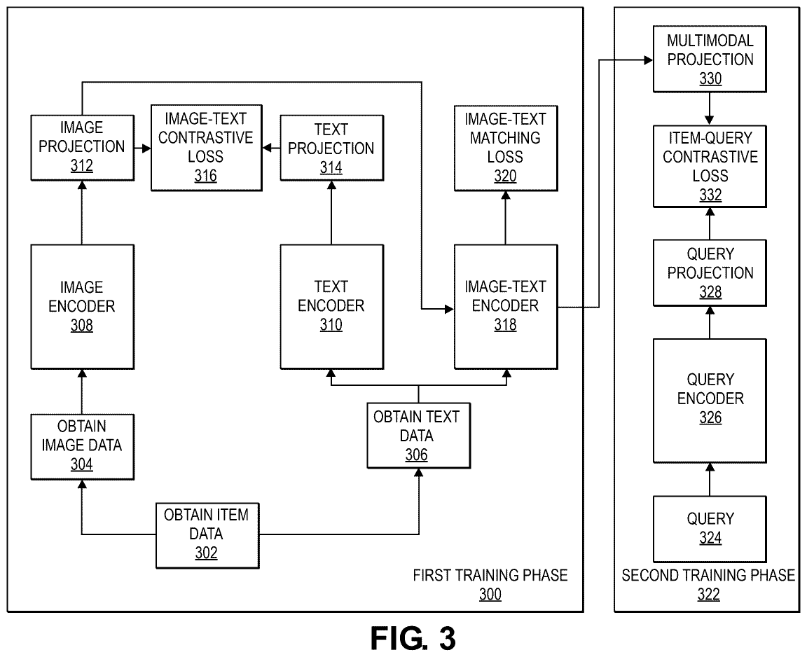

FIG. 3 shows a hybrid diagram illustrating model architecture and training objectives according to embodiments. FIG. 3 illustrates, a computer-implemented method for training and utilizing a multimodal machine learning model, which is designed to generate generalized item representations for diverse downstream applications. The training process, which may be executed by the central server computer 102, includes two machine learning models: a first model focused on learning multimodal item embeddings and a second model dedicated to aligning user query embeddings with item embeddings.

The method illustrated in FIG. 3 can be a training process to train a first machine learning model and a second machine learning model. The first machine learning model can be trained during a first training phase 300. The second machine learning model can be trained during a second training phase 322.

One aspect of the system according to embodiments can be to build generalized item (e.g., product) representations for different downstream applications. For example, for an image de-duplication task where service providers are uploading item images to the item database may only utilize an image-only encoder. An image retrieval task could utilize the text-only and image-only encoders in which the encodings are aligned in the embedding space. Therefore, embedding models according to embodiments can support different modalities to accommodate task-specific modeling requirements. Based on this multi-modal criteria, embodiments utilize a vision-language pre-training framework of bootstrapping language-image pre-training for unified vision-language understanding and generation model (BLIP), which includes of two uni-modal encoders (e.g., image and text) and one image-grounded text encoder. To fine-tune the model for a search ranking use case, a query encoder can be utilized. The query encoder can include a language transformer to encode normalized free text search term provided by a user.

The first machine learning model can be configured to generate multimodal embeddings that combine image information and textual information about items. Training can begin by obtaining item data from an item database, which may include various fields such as item title, image, description, detail, aisle category, etc. The first machine learning model can extract image data and text data from the item records of the item database. The first machine learning model can then process these inputs through the respective encoders to obtain image embeddings and text embeddings. These embeddings can used to compute an image-text contrastive (ITC) loss and an image-text matching (ITM) loss, which are jointly optimized to improve the quality and alignment of multimodal representations. The image-text contrastive loss and the image-text matching loss can be optimized over a number of training iterations. The text and image-text encoders can share model weights and are continually pre-trained on large item catalog datasets comprising hundreds of thousands of image-title pairs. The first machine learning model can include a BLIP model.

The second machine learning model can be configured to learn and align (e.g., match) query embeddings to the multimodal item embeddings created by the first machine learning model. The second machine learning model can include a query encoder and can learn relationships between query embeddings, created from user queries, and multimodal embeddings, created by the first machine learning model. During training, the computer can obtain query data, which can be classified as either positive (e.g., relevant) or negative (e.g., irrelevant) with respect to the associated item data.

At step 302, a computer can obtain item data from a database (e.g., an item database). The item data can include data related to an item. The item data can include an image of the item, a description of the item, a title of the item, a price of the item, and/or any other information that relates to the item. The computer can iteratively obtain item data over a number of training iterations. During each training iteration, the computer can obtain a different item data from the item database.

As an illustrative example, the item data can represent a container of tomatoes. The item data can include a price of $4.99, a size of 16.5 ounces, a title of “sweet heavenly salad tomatoes,” and an image of the item.

The item database can contain various types of information related to items. The item database can include item data that is provided by service providers. The item database can also include item data that is internally generated about the item. A list of any number of items from the item database can be created and utilized for pre-training and evaluation tasks. For example, the item database can include 100,000 items, 400,000 items, 1,00,000 items, etc.

While the item database contains many different fields, the following fields can be utilized for training the first machine learning model: 1) title: the “name” of the item as shown to end users, 2) image: a standardized image of the item, 3) description: typically a single sentence elaborating some additional information (e.g., dimensions for furniture), 4) detail: typically a few lines or a paragraphs explaining item features, 5) aisle category: the category of the item classified as per taxonomy (e.g., drinks, snacks).

For the following description, the item title and the item image are described to train the first machine learning model. However, it is understood that additional item data fields (e.g., item description, item cost, item video, item weight, item size, etc.) can be utilized to train the first machine learning model. The following description describes the item title and item image since the title and image are likely to receive the highest user attention in an application as only these two fields are visible to the users in the category or search result cards.

At step 304, the computer can obtain image data from the item data. The image data can be the image of the item. The computer can obtain the image data by extracting the image data from the item data. The extraction process may involve identifying the appropriate image field within the item record, retrieving the binary or encoded image file, and preparing the image data for subsequent processing. The image data may then be stored temporarily in memory or in a designated data structure for use in downstream computational steps.

At step 306, the computer can obtain text data from the item data. The computer can obtain the text data by extracting the title and/or other text from the item data. The text data may include, but is not limited to, the item title, name, short description, detailed description, or any other textual attribute associated with the item as stored in the item database. The computer can obtain the text data by parsing structured fields within the item database and/or otherwise aggregating one or more fields as needed to form a cohesive textual input representative of the item. The resulting text data is prepared and stored for further processing in subsequent steps.

At step 308, the computer can generate an image embedding for the image. The computer can generate the image embedding using an image encoder. The image encoder can be a component of the machine learning architecture designed for visual feature extraction. The image encoder can include a deep neural network, such as a convolutional neural network (CNN), which has been pre-trained and/or fine-tuned on relevant datasets that include images. The image encoder can receive the raw or pre-processed image data as input and can generate an image embedding. The image embedding can be a fixed-length numerical vector that encapsulates visual characteristics of the item. The item embedding can serve as a compact and information-rich representation of the item's visual appearance.

At step 310, the computer can generate a text embedding for the text data. The computer can generate the text embedding using a text encoder. The text encoder can include a machine learning model, such as a transformer-based neural network, such as BERT or a comparable language model. The text encoder can be capable of converting natural language input into a dense vector representation. Upon receiving the text data, the text encoder can generate a text embedding. The text embedding can be a fixed-length vector that captures the semantic content and key attributes described in the item's textual information. The text embedding can indicate a meaning, context, and/or distinguishing features of the item as indicated by the text.

The computer can then begin determining an image-text contrastive loss. However, the image embedding cannot be directly compared to the text embedding as they may be in different dimensional spaces. Before calculating the contrastive loss for the first machine learning model, the computer can project both the image embedding and the text embedding into a shared or aligned embedding space. This can ensure that the embeddings from the two modalities are directly comparable (e.g., they have the same dimension and similar geometric properties).

The computer can determine a projection of each embedding using a projection process. Projection can serve several purposes in such multimodal systems. Image and text encoders often generate embeddings that differ in dimensionality. The projection process can ensure that both image embeddings and text embeddings are mapped to a common dimensional space, thereby enabling direct comparison and interaction between the two modalities. Even when image embeddings and text embedding share the same dimensionality, the underlying structure or meaning of their respective vector spaces may not be inherently compatible. Projection heads can be employed to transform the embeddings in a manner that enhances the compatibility of their semantic structures, thus facilitating effective contrastive learning and other joint optimization objectives. Projection layers are trainable components that can be optimized for specific downstream tasks, such as minimizing contrastive loss. Through training, these projection layers can learn to apply transformations that maximize the overall performance of the multimodal model, ensuring that the joint representations of images and text are well-suited for the intended applications.

At step 312, after generating the image embedding, the computer can determine an image embedding projection using a projection process. Projection can include a process of transforming a raw output embedding from an encoder (e.g., an image encoder) into another vector space or dimension. The projection process can aid in aligning the image embedding with embeddings of other modalities, such as with text embeddings.

The computer can determine the image embedding projection by passing the image embedding through one or more neural network layers (e.g., fully connected layers), which can be referred to as a projection head. The projection head maps the original embedding to a new, lower or higher dimensional space, where the image embedding projection can more effectively interact with other types of data (e.g., text embeddings) and/or be utilized for contrastive learning.

At step 314, after generating the text embedding, the computer can determine a text embedding projection using a projection process.

The projection process, which can be a text projection process, can involve transforming the raw text embedding, which can be a dense, fixed-length vector that encapsulates the semantic content and distinguishing features of the item's associated textual data, into a new vector representation within a shared embedding space.

The computer can apply a projection head to the text embedding to create the text embedding projection. The projection head may include a single linear transformation (such as a fully connected layer), or the projection head may include multiple layers with nonlinear activation functions.

The projection process can be trainable and can be optimized during model training to improve the performance of the overall multimodal system. By learning an effective transformation, the projection head ensures that the projected text embedding is not only mathematically compatible with image embeddings (or other modality embeddings), but also semantically meaningful within the context of the model's objectives.

At step 316, the computer can utilize the image embedding projection and the text embedding projection to determine an image-text contrastive loss. This loss function can be optimized over training iterations to minimize the loss by adjusting model weights in the first machine learning model.

To determine the image-text contrastive loss, the computer can utilize a contrastive machine learning model. An objective of contrastive loss is to encourage embeddings derived from matching image-text pairs (e.g., an image and its corresponding descriptive text) to be positioned close together in an embedding space, while simultaneously driving apart the embeddings of non-matching or irrelevant pairs. This can be achieved by the computer measuring the similarity between embeddings, using metrics such as cosine similarity or Euclidean distance, and formulating a loss that penalizes large distances between related pairs and small distances between unrelated pairs.

The contrastive training process can include the following steps. The computer can process a batch of image-text pairs, generating and projecting their respective embeddings. For each pair, the computer can determine a similarity score between the image embedding projections and the text embedding projections. A contrastive loss function (e.g., information noise contrastive estimation (InfoNCE) or triplet loss) can quantify how well the model distinguishes positive (matching) pairs from negative (mismatched) pairs within the batch. The loss can be aggregated over the batch to provide a single value representing the model's current performance.

Optimization can occur over repeated training iterations. The model's parameters, including those of the image encoder, the text encoder, and their respective projection heads, are iteratively updated to minimize the contrastive loss. This can be accomplished using gradient-based optimization algorithms such as stochastic gradient descent (SGD). As the training progresses, the model becomes increasingly effective at aligning visual and textual modalities, ensuring that matching pairs become more similar in the embedding space, and that non-matching pairs are more distinct.

At step 318, after obtaining the image embedding projection, the computer can utilize an image-text encoder to encode a combination of the image embedding projection and the text data to obtain a multimodal embedding (e.g., an item data embedding).

This image-text encoder can be configured to accept the image embedding projection, which encapsulates salient visual features, together with the item's associated textual data, such as the title, description, or other relevant textual attributes. The image-text encoder can process these inputs (e.g., by concatenating or otherwise fusing the image and text representations) and can apply a series of neural network transformations to jointly encode the combined information into a multimodal embedding.

The outcome of this process is the creation of a single, dense multimodal embedding, for each item. This multimodal embedding can serves as a holistic representation that captures not only the visual characteristics of the item, but also its semantic content as expressed in text.

In certain implementations, the text encoder and the image-text encoder can share machine learning model weights. By sharing machine learning model weights, some parameters or layers can be reused or jointly updated across both encoders, which can lead to more efficient learning and better alignment of visual and textual features. Shared weights are particularly advantageous when the underlying structures of the encoders are similar, such as in transformer-based models.

The resulting multimodal embedding can be utilized in a variety of downstream tasks, including classification, retrieval, recommendation, and semantic understanding, providing a robust foundation for advanced data analysis and application development.

At step 320, the computer can determine an image-text matching loss. This loss function can be optimized over training iterations to minimize the loss by adjusting model weights in the first machine learning model. The loss function can aid in training the multimodal system to accurately associate images with their corresponding textual descriptions and to differentiate between correct and incorrect pairings.

The objective function can assess how effectively the embedding reflects the true association between an item's visual and textual data. The image-text matching loss quantifies the discrepancy between correct matches and mismatches. The objection function can include binary classification loss, ranking loss, and/or contrastive/objective functions that directly optimize for matching accuracy. Optimization of this loss function can be conducted over multiple training iterations.

The first machine learning model's parameters, including those of the image encoder, the text encoder, and the image-text encoder, are updated to minimize the matching loss. The computer can utilize gradient-based optimization algorithms, such as stochastic gradient descent (SGD), to optimize the loss function. In some embodiments, the sharing of model weights between the text encoder and image-text encoder can further streamline the learning process, reduce the overall parameter count, and promote effective feature alignment across modalities. This system architecture can enhance the model's generalization capabilities and improve the quality of the multimodal representations learned.

The successful minimization of the image-text matching loss enables the first machine learning model to reliably associate items with their accurate textual descriptions, even when confronted with visually or semantically similar distractors. This capability supports robust and scalable applications in cross-modal retrieval, recommendation systems, semantic search, and content moderation, among others.

The computer can train the second machine learning model during the second training phase 322.

At step 324, when training the second machine learning model, the computer can obtain queries. A query can be a user query that is received from a user device (e.g., an end user device). The query can include natural language text, keywords, or any other form of structured or unstructured input provided by a user. The query can be obtained directly from the user device or from a query database that stores queries for training the second machine learning model. The query can be utilized in training data to train the second machine learning model.

During training of the second machine learning model, the computer can obtain a plurality of labeled training queries, that can include the query. The query can be a labeled training query. The labeled training query can include a query that is labeled with an indication of how well the query relates to a particular item (e.g., a similarity classification). As such, the labeled training query can include a user query that is labeled with a similarity classification in relation to an item associated with the user query.

The computer can obtain labeled training queries from a query database. The labeled training queries can include human annotated queries. In some embodiments, the computer can generate additional labeled training queries using a large language model. The computer can generate a plurality of additional labeled training queries based on the plurality of labeled training queries using a large language model. For example, the computer can generate labeled training queries as described in further detail below in reference to Table 1.

At step 326, the computer can generate a query embedding using a query encoder and the query. The query encoder can include a machine learning model that is configured to generate query embeddings from queries. The query encoder can be a transformer-based neural network (e.g., BERT, ROBERTa, etc.) or a dedicated embedding architecture. The computer can process the query with the query encoder. The query encoder can systematically analyze the semantic content, syntactic structure, and relevant contextual cues within the query, transforming it into the query embedding, which can be a dense fixed-length numerical vector. This query embedding serves as a compact and information-rich representation of the query's meaning, intent, and distinguishing attributes.

In some embodiments, the query encoder can include several additional steps. For example, the query encoder can include preprocessing routines to normalize the input, handle misspellings, or resolve ambiguities. The query encoder may also apply attention mechanisms or other neural network methods to focus on the most relevant parts of the query, thereby enhancing the quality and relevance of the resulting embedding.

At step 328, after generating the query embedding, the computer can generate a query embedding projection based on the query embedding. The computer can generate the query embedding projection using a projection process involving a projection head. The computer can generate the query embedding projection such that the query embedding projection is in a new vector space that is similar to a vector shared by multimodal embedding projections (as described in step 330, below). The computer can generate the query embedding projection to transform the query embedding into a new vector representation that is specifically tailored for compatibility with other embeddings in the system, such as those representing multimodal data. The projection head can include of one or more trainable neural network layers as described herein.

At step 330, the computer can obtain a multimodal embedding (e.g., an item data embedding) from the image-text encoder, which can be an output from the first machine learning model for a particular item. The computer can determine a multimodal embedding projection using the multimodal embedding. The computer can determine the multimodal embedding projection using a projection head as described herein.

The embeddings created by embodiments are generalizable and flexible, making them applicable to multiple downstream applications. Beyond CTR prediction, these embeddings can be used for image de-duplication, item recommendation, and cross-category search, providing a versatile solution for various tasks.

At step 332, the computer can utilize the query embedding projection and the multimodal embedding projection (e.g., the item embedding projection) to determine an item-query contrastive loss. This loss function can be optimized over training iterations to minimize the loss by adjusting model weights in the second machine learning model.

Such a contrastive training process can include training data that includes labeled queries that are associated with item data. The labeled queries can be labeled as “highly relevant” (HR), “moderately relevant” (MR), or “irrelevant” (IR). The labels for the queries can be labeled by a human or can be generated by a machine learning model, such as a large language model.

In the training data, a query can be a positive query or a negative query in relation to the associated item data. A positive query can indicate that the query is relevant to the item data. A negative query can indicate that the query is not relevant to the item data. For example, for the item data of tomatoes, a positive query can include “salad tomato,” whereas a negative query can include “milk.”

In order to align the item embedding and query embedding in the same space, a relevance dataset can be created which assigns a relevance label from {0: irrelevant, 1: moderately relevant, 2: highly relevant} to each <query, item> pair. A hybrid approach can include both human annotations and large language model (LLM) created annotations to create such a dataset. Specifically, in experiments, 700,000 human annotated relevance labels were used to fine-tune a language model to grade the relevance of any new <query, item> pair. In total, during the experiments, there were 32 million LLM-inferred relevance labels for such pairs, which covered 68,000 unique items and a large majority of search traffic. The distribution of the labels were {IR: 69%, MR: 20.5%, HR: 9.9%}.

For example, for fine-tuning to aid in label creation the computer can generate a prompt for a large language model to generate a label. The prompt can specify a role of the large language model and a definition of the different relevance labels. Moderately relevant items may require a longer definition and more examples since they may be related to many different concepts such as similarity and complementarity. After the description portion of the prompt, a list of <query, item> examples can be included into the prompt as illustrated in Table 1, below. Due to the prompt, additional training data for the second machine learning model can be created.

TABLE 1
example LLM prompt and query-item pairs

You are an AI online grocery shopping expert. Given a query
that a user searched for, and an item shown to the user, your
job is to understand the relevance of the item to the search query.
We classify the relevance of the item to the search query with
three distinct labels, that have the following definition:
Highly Relevant (relevance: 2): The item is exactly what you would
expect in the search results. The item is clearly helpful to show
to a user. This item fulfills the primary intent for the search term.
Moderately Relevant (relevance: 1): The item is a reasonable substitute
if the ideal item is not available. The item is similar to the ideal
item and fulfills the same general intent. These are often items under
a shared category but differ on specific attributes such as brand (soda:
Coke vs Pepsi), flavor (ice cream: chocolate vs vanilla), ingredient (flour:
almond flour vs coconut flour), nutritional content (milk: 2% vs whole)
and size (Drinking Water (1 gal) vs Spring Water (16.9 oz × 35 ct)).
This also includes items under different/sister categories that fulfill the
same intent, such as toilet paper vs wet wipes (used in the bathroom) and
waffles vs pancakes (similar breakfast dishes). The item might also be
somewhat relevant if it fulfills a secondary intent for the search term. For
instance, some minority of users would have reasonably expected a
different ideal item. In numerous instances, there will be a partial
overlap between a segment of the search query and the item's name.
Irrelevant (relevance: 0):: Item does not belong in the search results for
this query. The item is clearly not helpful to show to a user.
Examples:
search query: arugula
item name: BrightFresh Micro Arugula (1.75 oz)
relevance: 2
---
search query: arugula
item name: Spinach Bunch (bunch)
relevance: 1
---

As an example, the query can be “salad tomato” that is associated with an item embedding associated with item data of the “sweet heavenly salad tomatoes” with a label of “highly relevant.” The computer can train the second machine learning model to predict item data embeddings. The second machine learning model can predict the relationship between the item data embedding and the query as being “highly relevant,” “moderately relevant,” or “irrelevant.” The prediction can be compared to the label to determine how well the second machine learning model performed. The computer can update the second machine learning model using an item-query contrastive loss to update model weights.

For the second machine learning model, the query-encoder and the multimodal projection layers can be trained using the item-query contrastive loss using item data from the item database and corresponding positive and negative queries. Contrastive loss can include an objective function used in machine learning, particularly within representation learning and metric learning paradigms, to train models that can effectively distinguish between similar and dissimilar data pairs. One aspect of contrastive loss is to ensure that, in the learned embedding space, embeddings of similar or related pairs are drawn closer together, while those of dissimilar or unrelated pairs are pushed further apart. During training, the model processes batches of data where each batch contains both positive pairs (e.g., an image and its corresponding text description) and negative pairs (e.g., an image and an unrelated text). The loss function quantifies the similarity between the embeddings of these pairs using metrics such as cosine similarity or Euclidean distance. For positive pairs, the model is penalized if their embeddings are not sufficiently close. For negative pairs, the model is penalized if their embeddings are not sufficiently distant. This approach can encourage the machine learning model to learn representations that are robust and discriminative, facilitating downstream tasks such as clustering, retrieval, classification, and cross-modal matching.

During training of the second machine learning model, the computer can initialize the query encoder. The computer can align the item embedding with the query embedding by minimizing a contrastive loss in the projection space of the image-text encoder (e.g., of step 318) and the query encoder (e.g., of step 326). The computer can utilize a query encoder model where the first 8 layers are frozen. The item-query contrastive loss (IQC) can be defined as:

$$IQC = {\sum }_{i = 1}^{B} - log ( \frac{{e}^{s i m ( {C}_{i} , {Q}_{i}^{+} / τ )}}{{e}^{s i m ( {C}_{i} , {Q}_{i}^{+} / τ )} + {\sum }_{j = 1}^{N} {e}^{s i m ( {C}_{i} , {Q}_{ij}^{-} / τ )}} )$$

Cᵢ is the multi-modal hidden representation of an i-th item,

$${Q}_{i}^{+}$$

is a positive (e.g., relevant) query for the catalog,

$${Q}_{i j}^{-}$$

is the j-th negative query among N negative samples for the i-th item. sim is a cosine similarity function and t is a temperature parameter. This loss is averaged over a batch size B.

In some embodiments, in order to facilitate the item-query contrastive loss, the computer can create and utilize tuples in the structure of (item, positive query, [negative queries]) from the query item relevance dataset. The sampling procedure can be performed as follows.

First, the computer can retrieve items with at least one moderately relevant or highly relevant labeled query. For each of the items, the computer can randomly sample at most a predetermined number of positive examples (e.g., 50, 75, 100, 110, 130, 150, etc.) among the moderately relevant or highly relevant queries in a predetermined ratio (e.g., 1:1.5, 1:1.75, 1:2, 1:2.25, 1:2.5, etc.) to focus on the more informative, but infrequent highly relevant queries. Based on the selected rations, on average, each unique item can be paired with 30, 50, 80, etc. positive queries. For each such (item, positive query) tuple, the computer can sample a list of negative examples (e.g., 3, 5, 7, 10, 14, 16, 20, etc.). If the positive query is highly relevant, the computer can look for negative queries from the set of irrelevant queries or moderately relevant queries. If the positive query is moderately relevant, the computer can sample negatives from irrelevant queries. In cases when the computer cannot find enough negatives from the relevance dataset, the computer can generate proxy negatives by using highly relevant queries for another random item from a different category. Further, when all sampled negatives are from irrelevant queries, the computer can randomly replace one with a proxy negative to promote more diversity. This can result in, for example, a total 1.4 million entries of (item, positive query, [negative queries]) tuples. This overall sampling strategy strikes an advantageous balance of hard negatives (highly relevant queries vs moderately relevant queries) and diversified examples (irrelevant queries and random queries) for the contrastive loss learning process.

Various embodiments and implementation were evaluated. Although one goal is to develop item embeddings for different retrieval and ranking applications, the effectiveness of the pre-training strategy can be evaluated and it can be determined whether or not the generated embeddings are aligned to the domain. Qualitative and quantitative preliminary evaluations were evaluated on 1) an aisle category task and 2) an item-query relevance task.

For the aisle category task, the experiment checked if the embeddings are able to capture the aisle category of the items, despite not being provided explicitly during pre-training. For qualitative evaluation, the product embeddings were plotted following t-SNE (t-distributed stochastic neighbor embedding) dimensionality reduction and each point (e.g., item) was annotated with its ground truth category. For quantitative evaluation, this was modeled as a n-class classification task where the model predicts the category class.

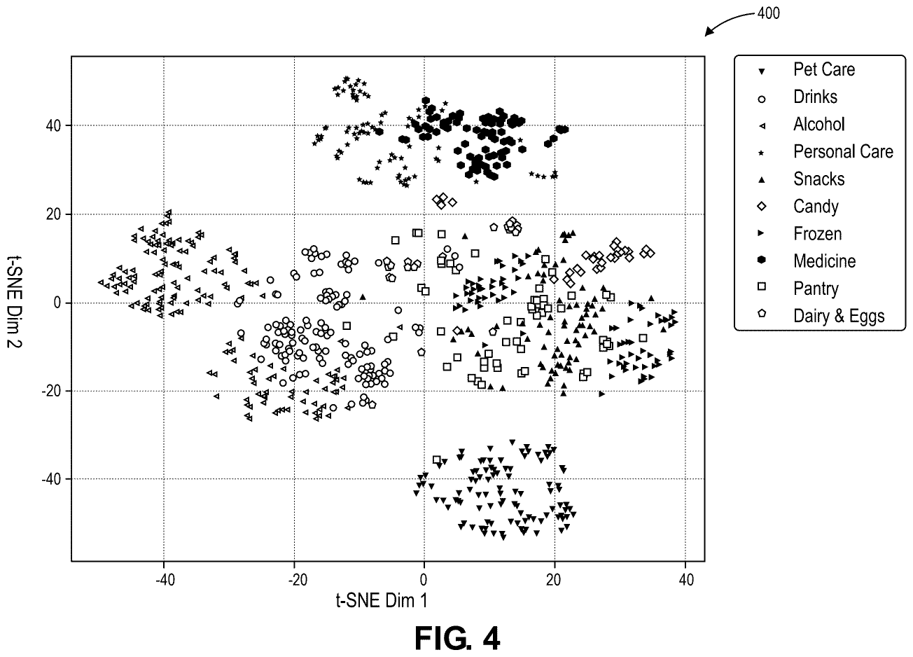

The experiment performed an 80-20 stratified split on the unique products identifiers within the kept-aside data to create the training and testing datasets. For the baseline model, the BLIP-14M model was used checkpoint and compare it with embodiments. A classifier was trained on top of the encoders, by passing the last hidden layer output of the image-text encoders through a dropout layer followed by a linear layer. The encoders were kept frozen and only trained the classification layer. It is observed that the model according to embodiments performs significantly better. It was noted that the baseline models fails to classify low-support classes, but the model according to embodiments performed relatively well on those owing to the continual pre-training. From the qualitative evaluation results shown in FIG. 4, it was observed that the classes are naturally clustered and semantically similar clusters are closer to each other.

FIG. 4 illustrates a plot 400 of item embeddings after t-SNE dimensionality reduction for top-10 aisle categories by frequency. Products from the same categories form clusters naturally. Similar clusters like drinks and alcohol are closer to each other. Cluster of unique categories like pet care are isolated from the majority mass. The plot 400 of item embeddings illustrates that embodiments successfully learn information about an item using the first machine learning model without needing to manually indicate each item as a particular category of item.

Experimental results were also obtained relating to the item-query relevance task. The item-query relevance task checked whether the item-query relevance was captured by the embeddings. The relevance was qualitatively evaluated by plotting the distributions of cosine similarities between the embeddings of product query pairs. This was modeled as a 3-class classification task where the classifier takes the pair of embeddings as features to predict the relevance label. As such, a first task evaluates the product encoders pre-trained in a first training phase to train the first machine learning model, while the second task accounts for the query encoder in the second phase to train the second machine learning model.

To prepare the dataset for the item-query relevance task, 10% of data points were sampled from a kept-aside dataset. Next, due to the class imbalance in the query relevance dataset, 50% of IR class samples were dropped. Finally, a 80-20 split was performed on the obtained data to generate the train and test sets. The BLIP-14M checkpoint was again used as the baseline. To build the classifier, the multi-modal embeddings were extracted from the image-text encoder and concatenated with the query embeddings to pass them through a dropout layer followed by a classification layer. For the BLIP model, the queries were encoded using the text encoder. The query encoder was utilized from the pre-trained model.

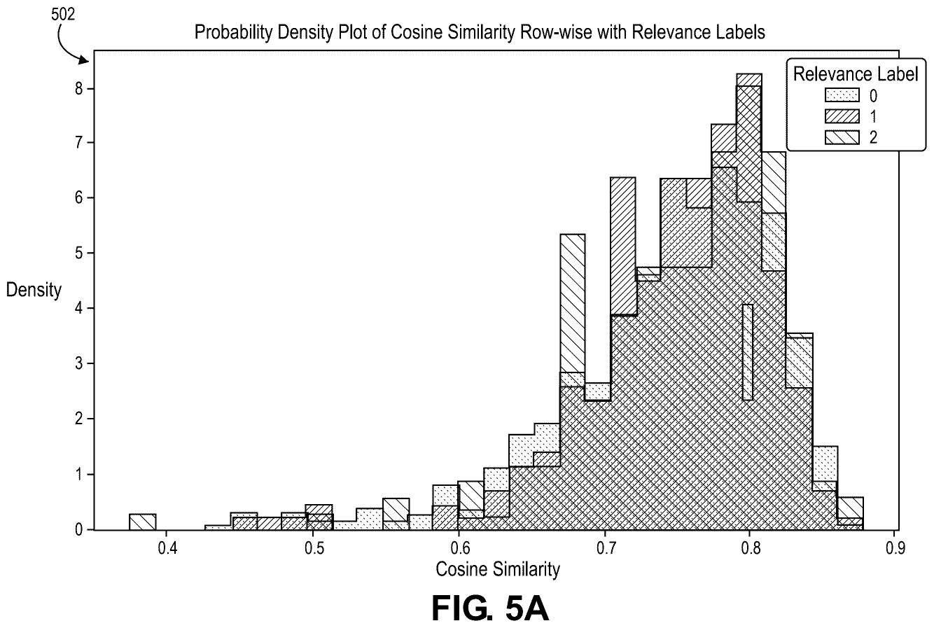

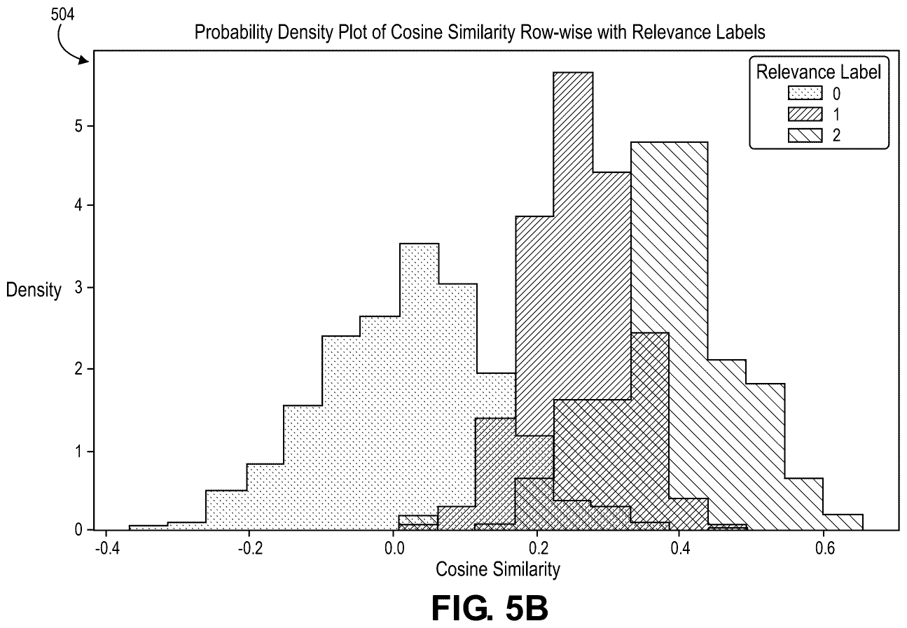

FIG. 5A illustrates a first probability density plot 502 of cosine similarity row-wise with relevance labels according to previous models (e.g., BLIP-14M). FIG. 5B illustrates a second probability density plot 504 of cosine similarity row-wise with relevance scores according to embodiments. From the preliminary evaluation shown in FIG. 5A and FIG. 5B, the pre-trained model is able to create significantly more separation between the three classes compared to the baseline.

The first probability density plot 502 illustrates the cosine similarity of three different classes (e.g., indicated as 0, 1, and 2) as predicted by previous models such as BLIP-14M. The three different classes have much overlap with one another and cannot be accurately predicted by the BLIP-14M model.

The second probability density plot 504 illustrates the cosine similarity of three different classes as predicted by embodiments. The three different classes are much more clearly separated. The separation between the three relevance classes illustrates the effectiveness of embodiments compared to previous methods. Embodiments more accurately identify different classifications of item-query relevance (e.g., irrelevant, moderately relevant, and relevant).

Another experiment included a search ranking experiment. Since, the trained item embeddings and query embeddings according to embodiments are vertically built for a range of different downstream applications, embodiments can be utilized for click-through rate prediction. This section focuses on a click-through rate (CTR) prediction task, which infers the probability of a user engaging with a shown item in an application. The item embedding can be retrieved from the identification of the based on an item and the query embedding based on the normalized search term from the user. The embeddings after the final projection layer in the encoders were, during the experiment, integrated as input features to a core deep neural net ranking model. Offline experiments were performed with ablation studies to investigate the best model architecture to make use of the embeddings. During the experiment, it was identified that the pre-trained embeddings outperformed the randomly initialized embedding (both frozen and trainable variants) in offline experiments, which indicates using semantic information of the products and queries to pre-train the embedding serves as a strong prior for downstream applications. The derived sequence features, capturing users' engagement signals using product embedding, contributed further improvement to the ranking model which shows the flexibility of building advanced features from the embeddings. Further, the item embedding was identified as highly generalizable to new items. Experiments showed that embeddings can capture the textual and visual clues of unseen items to predict user engagement.

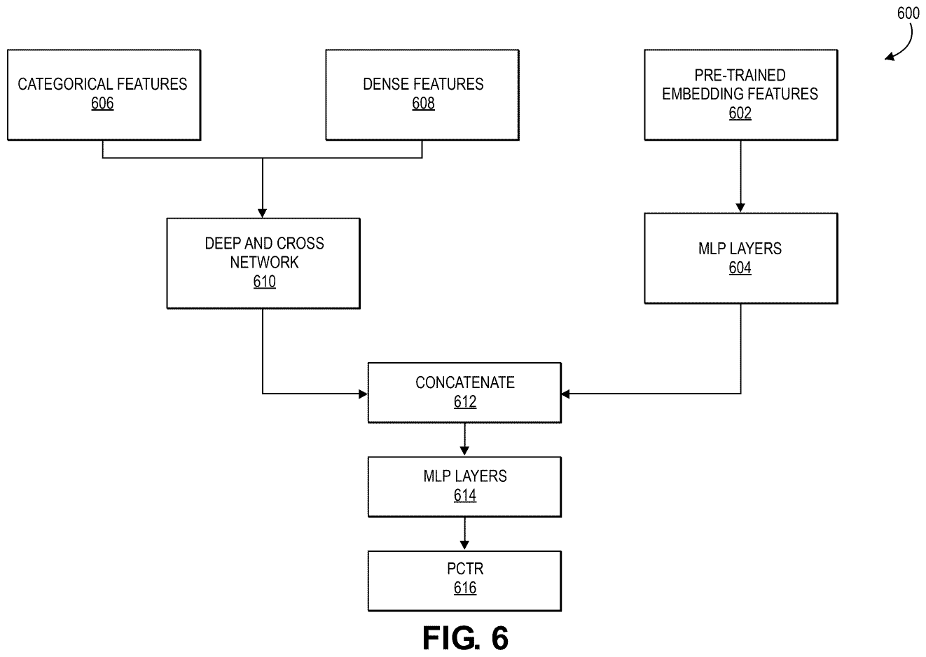

FIG. 6 shows a diagram illustrating model architecture 600 for integrating embedding features with another model according to embodiments. The diagram illustrated in FIG. 6 shows the model architecture 600 that was utilized during the search ranking experiment. FIG. 6 illustrates a model architecture for integrating embedding features of embodiments with an existing pCTR (probability click through rate) machine learning model.

First the problem will be formulated and the model setup for the CTR prediction task on the search surface will be discussed. Given a potential item candidate to be shown as items in an application when a user searches with a query string, the ranking model can accept the (sparse, dense, cross) categorical features 606 and the dense features 608 as input and return a value between [0, 1] as output. The output can be a pCTR 616, which is a probability of the user clicking the items in the application showing the item. The model in the experimental environment included a deep and cross network 610 variant trained on binary labels of historical user click engagements.

Next, the integration of the projected embeddings of the item embedᵢ, query embed_{q} and their derived features with the ranking model will be described. Systems according to embodiments can be designed to adopt a two-towers architecture: a DCN tower that behaves the same as a current production model, and a new tower that takes the pre-trained item and query embeddings and their derived features as input. The DCN tower can include pre-trained embedding features 602 (e.g., which include pre-trained item embeddings and pre-trained query embeddings from the first machine learning model and second machine learning model, respectively) and multilayer perceptron layers 604. The outputs from the two towers are concatenated 612 and go through a few fully connected layers (e.g., through a multilayer perceptron (MLP)) 614 before the final sigmoid layer that produces the output pCTR 616 in the range from 0 to 1. During the experiment, a few different architecture designs were iterated and it was discovered that separating the dense and sparse features from the new embeddings related features in the two-towers approach archived the best performance. This model promotes the crossing between the different embeddings before interacting with the existing features. The derived features are of two types: 1) similarity score between embeddings and 2) users' engagement list. The former is the cosine similarity of the embeddings such as cosine (embedᵢ, embed_{q}). One particular instance of the latter is the consumer_p84d_purchased_item_i64l, which is a list of item identifiers that the user purchased in the last 84 days on the platform. Then the system retrieves the item embeddings using the item's identifies as indices from the pre-trained embedding table. A mean pooling averages the retrieved embeddings and then pooled vector is fed to the model.

Table 2, below, shows the offline performance of different models that were trained during experiments with different architectures and features. Models were trained with 7 months of users' click engagements and evaluated on the following week of data. Therefore, the train/evaluation dataset was split in the time dimension unless specified. From the first section of the Table 2 (Evaluation Dataset=“Next week”), the new proposed model according to embodiments with the product, query embeddings and derived purchase history (AUC=0.7790) improved over the DCN-only baseline (AUC=0.7749) in terms of offline ROC-AUC result. With the same architecture and feature set, the experiment also evaluated the performance when the product and query embeddings were randomly initialized. Even when these random weights were frozen or trainable, the model overfits severely compared to the baseline version (AUC=0.77) which indicates the benefit of pre-training the embeddings.

To understand the contribution of different features, the experiment performed a feature importance analysis on the best model candidate using Captum, which is a model interpretability tool for PyTorch. There are implementations of many gradient and permutation-based algorithms to attribute model performance to features. During the experiment, it was discovered that the attribution is quite consistent across a few selected ones including integrated gradients, feature ablation, and feature permutation, therefore only the result of feature permutation is reported here. Among all features, query embedding, product embedding and the user's purchase history of products in past 84 days are the top-3 features respectively, beating all existing dense and sparse features by a large margin.

TABLE 2
pCTR experimental results

| Evaluation | | |
|---|---|---|
| Dataset | Model Variant | ROC-AUC |
| Next Week | DCN baseline | 0.7749 |
| | DCN + item + query + similarity | 0.7756 |
| | DCN + item + query + similarity + | ? |
| | purchase history (text-only | |
| | embedding) | |
| | DCN + item + query + similarity + | 0.7790 |
| | purchase history | |
| | DCN + item + query + similarity + | 0.7699 |
| | purchase history (random init + | |
| | frozen embedding) | |
| | DCN + item + query + similarity + | 0.7700 |
| | purchase history (random init + | |
| | trainable embedding) | |
| Next week + | DCN baseline | 0.7769 |
| users with | DCN + item + query + similarity + | 0.7876 |
| purchase history | purchase history | |
| Next week + | DCN baseline | 0.7439 |
| users without | DCN + item + query + similarity + | 0.7470 |
| purchase history | purchase history | |
| Next week + | Item (random init embedding) | 0.5034 |
| non-overlap | Item | 0.5915 |
| non-overlap | Item + query (random init embedding) | 0.5892 |
| | Item + query | 0.6678 |
| | Item + query + purchase history | 0.7265 |

The experimental results in Table 2 show that item embeddings (e.g., multimodal embeddings) according to embodiments can generalize over unseen data points (AUC=0.5915) while the sanity check with randomly initialized embedding predicts a random label (AUC=0.5034). While new items are introduced to the platform every day, unseen (normalized) queries only account for a minimum amount of traffic. Therefore, the experiment did not perform the split further on the query. That is a reason why the model with randomly initialized query embedding achieves an ROC-AUC greater than 0.5 as the random weight serves as an identification to learn the query-specific CTR. The pre-trained query embedding and purchase history (AUC=0.7265) also helps to boost the performance on this unseen product evaluation set.

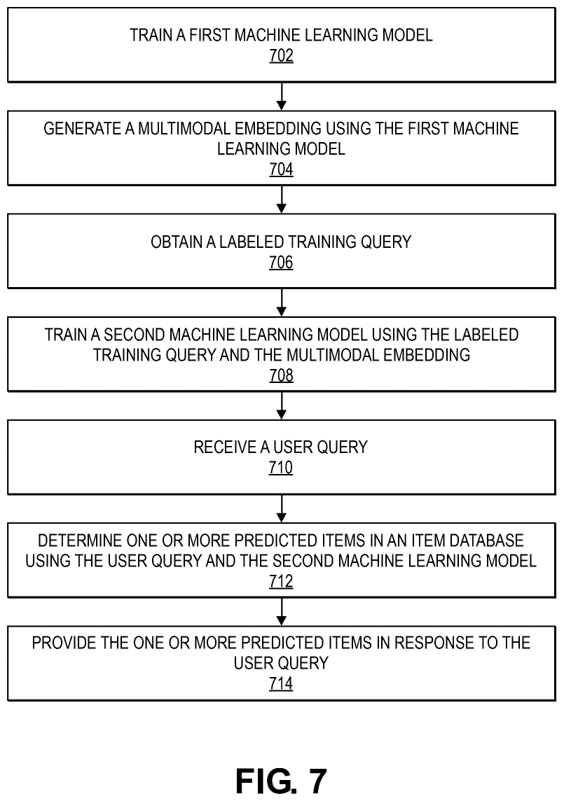

FIG. 7 shows a flow diagram illustrating a query and response method according to embodiments. The method illustrated in FIG. 7 can be performed by a computer such as a central server computer. The computer can train a first machine learning model and a second machine learning model.

In some embodiments, the computer can train the first machine learning model prior to training the second machine learning model. In other embodiments, the computer can train the first machine learning model and the second machine learning model in tandem, where the second machine learning model depends on outputs (e.g., multimodal embeddings) created by the first machine learning model.

At step 702, the computer can train the first machine learning model. The computer can train the first machine learning model iteratively over a plurality of training iterations. During a training iteration, the computer can obtain item data from an item database. The computer can obtain image data from the item data. The computer can also obtain text data from the item data. For example, the item data can include data related to an item. The item data can include data fields such as image, name, title, description, size, quantity, cost, etc.

After obtaining the image data, the computer can generate an image embedding based on the image data. The computer can generate the image embedding using an image encoder in the first machine learning model.

After obtaining the text data, the computer can generate a text embedding based on the text data. The computer can generate the text embedding using a text encoder in the first machine learning model.

After generating the image embedding and the text embedding, the computer can determine an image-text contrastive loss based on the image embedding and the text embedding. In some embodiments, the computer can determine the image-text contrastive loss based on data derived from the image embedding and the text embedding. For example, the computer can determine the image-text contrastive loss based on an image embedding projection, derived from the image embedding, and a text embedding projection, derived from the text embedding. The computer can generate the image embedding projection based on the image embedding using a first projection head. The computer can generate the text embedding projection based on the text embedding using a second projection head. In some embodiments, the first projection head can be the same as the second projection head. The computer can then evaluate the differences between the image embedding projection and the text embedding projection. For example, to determine the image-text contrastive loss, the computer can calculate similarity scores between image embedding projections and text embedding projections, applies a contrastive loss function to encourage close alignment of matching pairs and separation of non-matching pairs, and iteratively updates the model's parameters to minimize the loss. The computer can optimize the image-text contrastive loss by updating weights in the first machine learning model.

The computer can also determine an image-text matching loss based on a multimodal embedding that is generated based on the image embedding projection and the text data using an image-text encoder. The computer can optimize the image-text matching loss by updating the weights in the first machine learning model.

As such, the computer can optimize the loss functions in the first machine learning model. For example, the computer can minimize a contrastive loss between image embeddings and text embeddings (e.g., the image-text contrastive loss) and the matching loss of the image-text representations (e.g., the image-text matching loss). The image-text contrastive loss function serves to align the projected image embeddings and text embeddings within a shared vector space, ensuring that representations of corresponding image-text pairs are drawn closer together, while representations of non-matching pairs are separated. The image-text matching loss function quantifies the first machine learning model's ability to correctly match an image with its corresponding textual description, and penalizes incorrect associations.

In some embodiments, to further enhance the robustness and generalizability of the learning process, the optimization process can incorporate strategies for soft label creation and negative sampling. Such examples can be found in “Junnan Li, et al., 2022, Blip: Bootstrapping language-image pre-training for unified vision-language understanding and generation, International Conference on Machine Learning, PMLR, 12888-12900,” and “Junnan Li, et al., 2021, Align before fuse: Vision and language representation learning with momentum distillation, Advances in neural information processing systems 34 (2021), 9694-9705,” which are herein incorporated by reference in their entirety for all purposes. Soft label creation can involve assigning probabilistic labels to training samples, thereby introducing a degree of uncertainty that reflects the semantic similarities among classes or pairs. Negative sampling refers to the deliberate selection of non-matching image-text pairs during training, which can be used to reinforce the first machine learning model's ability to distinguish true associations from distractors. By leveraging these techniques, the system is able to achieve a more nuanced and effective optimization of the multimodal embedding space.

In some embodiments, in order to mitigate the technical problem of overfitting, the first eight layers of both the image encoder and the text encoder can be frozen, meaning that their parameters are held constant and excluded from gradient-based updates throughout the optimization process. This approach preserves the foundational feature extraction capabilities learned during pre-training, while allowing the subsequent layers and projection heads to adapt to the specific requirements of the multimodal task. Additionally, an early stopping criterion is implemented based on the evaluation score of the image-text matching loss. Training can be terminated at the point where the lowest evaluation score for the image-text matching loss is observed, thereby preventing the model from continuing to update its parameters in a manner that could lead to overfitting or diminished generalization performance.

At step 704, the computer can generate a multimodal embedding using the first machine learning model. The first machine learning model can be trained to generate multimodal embeddings based on item data from an item database as described herein. The multimodal embedding can represent an item.

At step 706, the computer can obtain a labeled training query. The computer can obtain the labeled training query from a query database. The labeled training query can be a user query that is labeled with an item relevance score to the query. For example, the labeled training query can be labeled as irrelevant, mostly relevant, or relevant for an item. In some embodiments, the multimodal embedding can relate to an item that associated with the labeled training query.

At step 708, after obtaining the multimodal embedding and the labeled training query, the computer can train the second machine learning model using the labeled training query and the multimodal embedding. The computer can train the second machine learning model as described herein. The computer can iteratively train the second machine learning model with multimodal embeddings and labeled training queries.

At step 710, after training the first machine learning model and the second machine learning model, the computer can receive a user query. The computer can receive the user query from a user device, such as an end user device. For example, a user of the end user device can input a text query into a search field in an application (e.g., a delivery application, a search application, etc.) on the end user device. The end user device can provide the query to the computer, which can be associated with the application.

At step 712, the computer can determine one or more predicted items in an item database using the user query and the second machine learning model. For example, the computer can input the user query into the second machine learning model. The second machine learning model can identify one or more items that are associated with item embeddings in the item database. The one or more predicted items can include items that can be presented to the end user in the application. Each predicted item can be associated with an item identifier.

At step 714, after determining the one or more predicted items, the computer can provide the one or more predicted items to the end user device in response to the user query. The end user device can display the one or more predicted items to the user via the application. In some embodiments, the end user can select a predicted item in the application for delivery to the end user via a transporter. The computer can aid in fulfilling the delivery of the item from a service provider location to the end user location via the transporter as described in reference to FIG. 1.

Embodiments of the disclosure have a number of advantages. For example, embodiments improve the relevance between items and queries. By aligning item and query embeddings in a shared space, embodiments capture nuanced semantic relationships that are often missed by traditional models. As an illustrative example, this approach provides a deeper understanding of how item features relate to user intent, improving the relevance of items show to users.

The model can handle complex queries and retrieve items that closely match user needs, even when those needs are indirectly expressed. This makes the search experience more intuitive and satisfying, as users see highly relevant items rather than loosely matched ones.

Embodiments also provide for multimodal embeddings with visual and textual Information. Unlike text-only or image-only models, systems and methods provided by embodiments jointly utilize both item images and titles, creating embeddings that represent items comprehensively. This is particularly beneficial for visually-driven searches, where users' decisions are influenced by the item's appearance. By leveraging visual cues alongside textual information, the model mimics the way humans interpret item information, providing a more natural and engaging search experience. This makes the solution adaptable to a wider range of user preferences and contexts.

Embodiments solve a number of technical problems. For example, for domain-specific fine-tuning of pretrained models, embodiments solve the technical problem of: existing pretrained models were trained on open-domain datasets like COCO or Flickr, which do not align well with the specific categories and semantic relationships in item catalogs. Adapting these models to effectively represent item data require a domain-specific fine-tuning strategy. Embodiments provide for a technical solution of, by continuing pretraining on a large dataset of catalog images and titles, encoders can adapt to the item catalog domain.

Embodiments also creating a scalable and balanced query-item relevance dataset. Embodiments solve the technical problem of: to align item and query embeddings, a large, balanced dataset of query-item relevance labels was necessary in previous systems and methods. Manually annotating such a dataset would be time-consuming, and the high variance in relevance levels required careful labeling to capture nuances in query intent. Embodiments provide for the technical solution of: utilizing used a hybrid approach, combining human annotations with large language model (LLM) inferences (e.g., fine-tuned GPT-3.5) to create a scalable query-item relevance dataset. This hybrid labeling approach reduces reliance on extensive human annotation efforts while maintaining high label quality.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
generating, by a computer, a multimodal embedding using a first machine learning model;
obtaining, by the computer, a labeled training query; and
training, by the computer, a second machine learning model using the labeled training query and the multimodal embedding to predict items related to multimodal embeddings based on queries.

2. The method of claim 1, further comprising:
training, by the computer, the first machine learning model.

3. The method of claim 2, wherein training the first machine learning model comprises:
obtaining, by the computer, item data from an item database;
obtaining, by the computer, image data from the item data;
obtaining, by the computer, text data from the item data;
generating, by the computer, an image embedding based on the image data;
generating, by the computer, a text embedding based on the text data;
determining, by the computer, an image-text contrastive loss based on the image embedding and the text embedding; and
optimizing, by the computer, the image-text contrastive loss by updating weights in the first machine learning model.

4. The method of claim 3, wherein generating the multimodal embedding comprises:
generating, by the computer, the multimodal embedding based on the image embedding and the text data.

5. The method of claim 3, wherein training the first machine learning model further comprises:
determining, by the computer, an image-text matching loss based on the multimodal embedding; and
optimizing, by the computer, the image-text matching loss by updating the weights in the first machine learning model.

6. The method of claim 3, wherein determining the image-text contrastive loss comprises:
generating, by the computer, an image embedding projection based on the image embedding;
generating, by the computer, a text embedding projection based on the text embedding; and
evaluating, by the computer, differences between the image embedding projection and the text embedding projection.

7. The method of claim 1, further comprising:
obtaining, by the computer, a plurality of labeled training queries comprising the labeled training query; and
generating, by the computer, a plurality of additional labeled training queries based on the plurality of labeled training queries using a large language model.

8. The method of claim 7, wherein the plurality of labeled training queries includes human annotated queries.

9. The method of claim 1, wherein training the second machine learning model comprises:
generating, by the computer, a query embedding based on the labeled training query;
generating, by the computer, a query embedding projection based on the query embedding;
determining, by the computer, a multimodal embedding projection based on the multimodal embedding;
determining, by the computer, an item-query contrastive loss based on the query embedding projection and the multimodal embedding projection; and
optimizing, by the computer, the item-query contrastive loss by updating weights in the second machine learning model.

10. The method of claim 1, wherein the first machine learning model includes an image encoder, a text encoder, and an image-text encoder, and wherein the second machine learning model includes a query encoder, and wherein the multimodal embedding is an item embedding that represents visual information and textual information of an item.

11. The method of claim 1, further comprising:
receiving, by the computer, a user query from an end user device, wherein the user query includes text;
determine, by the computer, one or more predicted items in an item database using the user query and the second machine learning model; and
providing, by the computer, the one or more predicted items to the end user device.

12. The method of claim 11, further comprising
receiving, by the computer from the end user device, a fulfillment request message comprising at least an item of the one or more predicted items;
providing, by the computer, the fulfillment request message to a service provider computer operated by a service provider, wherein the service provider initiates preparation of at least the item;
determining, by the computer, one or more transporter user devices;
providing, by the computer, the fulfillment request message to the one or more transporter user devices, wherein the one or more transporter user devices determine whether or not to request to accept the fulfillment request message;
receiving, by the computer, an acceptance message from a transporter user device of the one or more transporter user devices;
generating, by the computer, an update message indicating a status of the fulfillment request message; and
providing, by the computer, the update message to the end user device.

13. A computer comprising:
a processor; and
a non-transitory computer readable medium comprising code, executable by the processor for performing a method comprising:
generating a multimodal embedding using a first machine learning model;
obtaining a labeled training query; and
training a second machine learning model using the labeled training query and the multimodal embedding to predict items related to multimodal embeddings based on queries.

14. The computer of claim 13, wherein the labeled training query includes a user query that is labeled with a similarity classification in relation to an item associated with the user query.

15. The computer of claim 13, wherein the first machine learning model comprises an image encoder configured to generate an image embedding from image data, a text encoder configured to generate a text embedding from text data, and an image-text encoder configured to generate multimodal embeddings.

16. The computer of claim 15, wherein the text encoder and the image-text encoder share machine learning model weights.

17. The method of claim 15, wherein training the second machine learning model comprises:
generating a query embedding based on the labeled training query;
generating a query embedding projection based on the query embedding;
determining a multimodal embedding projection based on the multimodal embedding;
determining an item-query contrastive loss based on the query embedding projection and the multimodal embedding projection; and
optimizing the item-query contrastive loss by updating weights in the second machine learning model.

18. A system comprising:
an item database; and
a computer comprising:
a processor; and
a non-transitory computer readable medium comprising code, executable by the processor for performing a method comprising:
generating a multimodal embedding for an item of the item database using a first machine learning model;
obtaining a labeled training query; and
training a second machine learning model using the labeled training query and the multimodal embedding to predict items related to multimodal embeddings based on queries.

19. The system of claim 18, further comprising:
an end user device, wherein the method further comprises:
receiving a user query from the end user device;
determine one or more predicted items in the item database using the user query and the second machine learning model; and
providing the one or more predicted items to the end user device.

20. The system of claim 18, wherein the method further comprises:
training the first machine learning model, wherein training the first machine learning model comprises:
obtaining item data from the item database;
obtaining image data from the item data;
obtaining text data from the item data;
generating an image embedding based on the image data using an image encoder in the first machine learning model;
generating a text embedding based on the text data using a text encoder in the first machine learning model;
determining an image-text contrastive loss based on the image embedding and the text embedding; and
optimizing the image-text contrastive loss by updating weights in the first machine learning model.
